(19) United States
(12) Patent Application Publication
(10) Pub. No.: US 2004/0017490 A1
(43) Pub. Date: Jan. 29, 2004

(54) Image-capturing device controlled through internet and method for operating the same

(76) Inventor: Chih-Chung Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,662

(22) Filed: Nov. 7, 2002

(30) Foreign Application Priority Data
Jul. 25, 2002 (TW) 091116643

(51) Int. Cl. H04N 5/76

(52) U.S. Cl. 348/231.99

(57) ABSTRACT

The present invention discloses an image-capturing device and method for receiving signals from an external network. The image-capturing device includes: an image-capturing module for capturing an image and for transforming the image into a digital image signal, a first processor electrically connected to the image-capturing module for controlling operation of the image-capturing module, a first memory electrically connected to the first processor for storing data and program codes of the first processor, a second processor electrically connected to the first processor for receiving operation signals to control operation of the image-capturing device, a second memory electrically connected to the second processor for storing data and program codes of the second processor, a network controller electrically connected to the second processor for receiving signals transmitted from an external network, and a third memory electrically connected to the first memory thereby storing the digital image signal, wherein when the network controller receives a first signal transmitted from the external network, the network controller transmits a second signal corresponding to the first signal to the second processor, and then the second processor transmits a third signal corresponding to the second signal to the first processor, and then the first processor controls the image-capturing module with the third signal to transmit the digital image signal transformed by the image-capturing module through the external network.

### BACKGROUND OF INVENTION

1. Field of the Invention

The invention relates to an image-capturing device and method for operating the same, and more particularly to an image-capturing device and method for receiving a controlling signal, generated by a remote computer, through the network to process a captured image.

2. Description of the Prior Art

In complying with the growth of the network, users have made use of digital cameras to transform analog image signals into digital image signals for displaying from a computer terminal. With this specific function of the digital camera, high-resolution images taken by the user can be transmitted to his remote friends and relatives through a network or an Internet. Therefore, the digital camera has become one of the most popular electronic products in recent years. Moreover, since the resolution of the digital camera is being raised continuously, the appliance of the digital camera is not limited only to forming images anymore.

The principle of the digital camera shall be described hereinafter. First, the user makes use of the lens of the digital camera to capture images. Then, a charge-coupled device (CCD) is used to receive the light transmitted from the lens and then transforms the light into the digital image signals. The processed digital image signals will be stored in the memory device of the digital camera through other procedures, i.e., the digital signal processing and the image compression, etc.

The conventional digital camera comprises the following characteristics:

1) Instant display: The digital camera is an electronic image-capturing device. The digital camera can display taken images instantly on its liquid crystal display, and the user can inspect the images immediately by way of the connection to either a computer or a television with a transmission line. Certainly, the user also can choose the captured images through the liquid crystal display of the digital camera. After that, the digital camera will be capable of processing the chosen images, i.e., storing the processed images into the memory device of the digital camera for further purposes.

2) Compatibility with different computers: when a computer interface cooperates with the digital camera, the digital camera serves as an image-inputting equipment of a computer. The digital image signals captured by the digital camera can be further edited by an image processing software of the computer, and then the edited digital image signals can be stored in a hard disk or printed out by a printer.

Although the conventional digital cameras possess the above-mentioned advantages, the only method of capturing images must be a manual operation to the digital camera. The user must directly and closely operate the digital camera to process the captured image. That is, a user located at a remote port cannot monitor process the images, which are being captured by the conventional digital camera, through a network. Understandingly, the user can not control the remote digital camera via the network, either.

### SUMMARY OF INVENTION

It is therefore a primary objective of the claimed invention to provide an image-capturing device with functions of controlling the image-capturing device at a remote port on the network to process the being-captured images, beside both monitoring and recording images. Simultaneously, the image-capturing device still can retain images of high quality.

It is a secondary objective of the claimed invention to provide a method for controlling the image-capturing device from a remote computer via the network for more convenience and better efficiency.

According to the preferred embodiment of the claimed invention, the image-capturing device comprises an image-capturing module for capturing an image and transforming the image into a digital image signal, a first processor electrically connected to the image-capturing module for controlling the operations of the image-capturing module, a first memory electrically connected to the first processor for storing data and program codes of the first processor, a second processor electrically connected to the first processor for receiving operation signals to control the operations of the image-capturing device, a second memory electrically connected to the second processor for storing data and program codes of the second processor, a network controller electrically connected to the second processor for receiving signals transmitted from an external network, and a third memory electrically connected to the first processor for storing the digital image signal. Correspondingly, a method for controlling the image-capturing device via the network is also disclosed in the preferred embodiment of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of the image-capturing device of the present invention.

FIG. 2 is a schematic diagram of the image-capturing device of the present invention, cooperating with a network.

### DETAILED DESCRIPTION

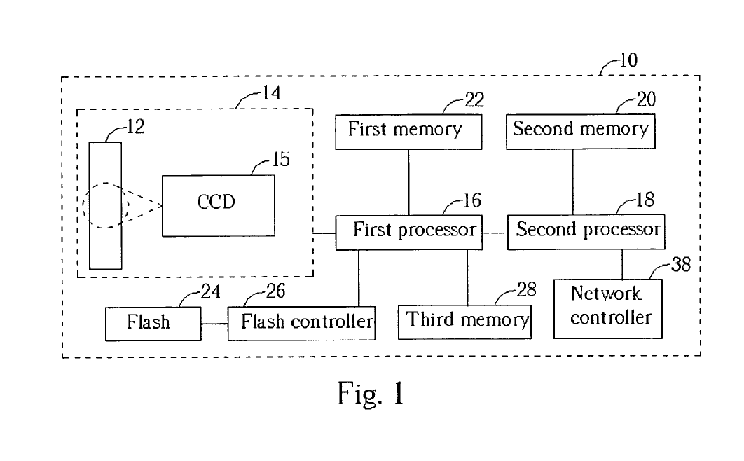

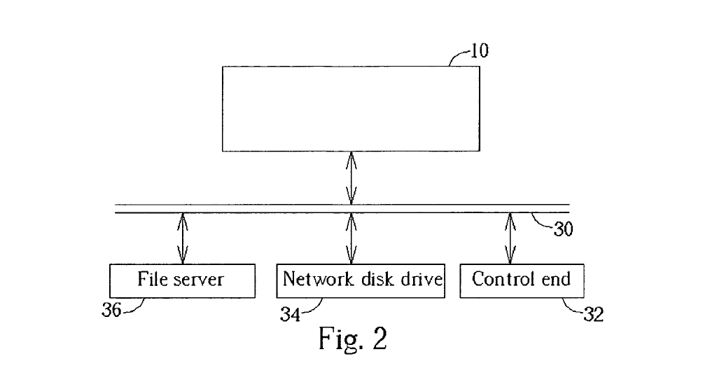

Please refer to FIG. 1 and FIG. 2. FIG. 1 is a block diagram of an image-capturing device 10 in accordance with the present invention. FIG. 2 is a schematic diagram of the image-capturing device 10 in accordance with the present invention cooperating with a network 30. The image-capturing device 10 comprises an image-capturing module 14 for capturing an image and transforming the image into a digital image signal, a first processor 16 electrically connected to the image-capturing module 14 for controlling the operations of the image-capturing module 14, a first memory 22 electrically connected to the first processor 16 for storing data and program codes of the first processor 16, a second processor 18 electrically connected to the first processor 16 for receiving the operation signals to control the image-capturing device 10, a second memory 20 electrically connected to the second processor 18 for storing data and program codes of the second processor 18, a network controller 38 electrically connected to the second processor 18 for receiving an operation signal, generated from a control end 32 shown in FIG. 2, through the network 30 and transmitting the operation signal to the second processor 18, a third memory 28 electrically connected to the first processor 16 for storing the digital image signal transformed by the image-capturing module 14 under control of the first processor 16, a flash controller 26 electrically connected to a flash 24 and the first processor 16 for controlling the flash 24 according to the operation signal received from the first processor 16. The network 30 can be builtover a wireless, an Internet, or a local area network (LAN). It notes that the first and second processors 16, 18 can be designedly integrated to be a unitary processor unit with the same function if necessary.

The image-capturing module 14 comprises a lens set 12 and a charge-coupled device (CCD) 15. The CCD 15 is used for receiving the light transmitted from the lens set 12 and transforming the light into digital image signals. The CCD 15 comprises a plurality of light-sensing cells arranged in rectangle or beehive patterns. Each light-sensing cell can be a semiconductor unit for recording the variance of the light, and the surface of each light-sensing cell has the capability of storing electric charges. When the surface of the light-sensing cell is exposed to the light, the light-sensing cell will generate a different electric charge reaction. The combination of the signals generated from all the light-sensing cells of the CCD constitutes an integrated digital image signal.

Please refer to the illustration of FIG. 2, which shows a schematic diagram of the cooperation between the image-capturing device 10 and the network 30. The control end 32 can be a computer that generates various signals to control the image-capturing device 10. For instance, when the control end 32 sends an inspection signal, the inspection signal will be transmitted to the network controller 38 inside the image-capturing device 10 through the network 30. After the network controller 38 depends on attitude of the inspection signal to determine that the inspection signal is transmitted to the second processor 18, which then transmits a signal related to the inspected image to the first processor 16. Afterwards, the first processor 16 will transmit the digital image signal, transformed by the image-capturing module 14 to the control end 32, through the network controller 38 and network 30. At this moment, the control end 32 can display images, captured by the image-capturing device 10, from the screen of the computer. For another example, when the control end 32 sends a storing signal, the storing signal will be transmitted to the network controller 38 inside the image-capturing device 10 through the network 30. Afterward, the network controller 38 depends on attitude of the storing signal to determine that the storing signal is transmitted to the second processor 18, which then transmits a signal related to the stored image to the first processor 16. The first processor 16 stores the digital image signals, transformed from the images, into the third memory 28, as soon as the image-capturing module 14 takes the images. The third memory 28 can be designed as a compact flash card or another similar memory component. In addition, the control end 32 also can be designed to control the image-capturing device 10 to store the taken image data into an external receiving terminal, i.e. a network disk drive 34 or a file server 36, through the network 30. Certainly, the control end 32 also can be designed to send other signals such as a controlling focal length signal or a diaphragm signal, etc for controlling the of the lens set 12 inside the image-capturing module 14.

When the control end 32 would like to store the images taken by the image-capturing device 10 and to find out the insufficiency of brightness of the image through the computer screen of the control end 32, the control end 32 also can send a flash signal, via the second processor 18 and the first processor 16, to the flash controller 26 thereby controlling the flash 24.

In contrast to the conventional digital camera, the present invention can use a computer to send various control signals to the digital camera. Through a network, each of operations of the image-capturing device can be performed through a remote port. Thus, the present invention can cover not only the appliance of the conventional digital camera but also other new appliances with respect to a remote inspection and transmission of the digital image data.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image-capturing device for receiving signals from an external network, the image-capturing device comprising:
an image-capturing module for capturing an image and for transforming the image into a digital image signal;
a first processor electrically connected to the image-capturing module for controlling operation of the image-capturing module;
a first memory electrically connected to the first processor for storing data and program codes of the first processor;
a second processor electrically connected to the first processor for receiving operation signals to control operation of the image-capturing device;
a second memory electrically connected to the second processor for storing data and program codes of the second processor;
a network controller electrically connected to the second processor for receiving signals transmitted from an external network; and
a third memory electrically connected to the first memory thereby storing the digital image signal, wherein when the network controller receives a first signal transmitted from the external network, the network controller transmits a second signal corresponding to the first signal to the second processor, and then the second processor transmits a third signal corresponding to the second signal to the first processor, and then the first processor controls the image-capturing module with the third signal to transmit the digital image signal transformed by the image-capturing module through the external network.

2. The image-capturing device of claim 1, wherein the image-capturing module comprises a lens set and a plurality of light-sensing cells for receiving light transmitted from the lens set and for transforming the light into the digital image signal.

3. The image-capturing device of claim 1, wherein the external network is a wireless, an Internet, or a local area network.

4. The image-capturing device of claim 1, wherein the second processor is capable of transmitting the digital image signal transformed by the image-capturing module to an external receiving terminal via the network.

5. The image-capturing device of claim 4, wherein the external receiving terminal is a file server or a networking storage.

6. The image-capturing device of claim 1, wherein the third memory is a compact flash card.

7. The image-capturing device of claim 1 further comprising a flash and a flash controller electrically connected to the first processor for controlling operation of the flash according to signals transmitted from the first memory.

8. A method for processing real-time images via an external network, comprising:
generating a first signal by a remote computer, according to required operation;
transmitting the first controlling signal to a network controller via the network;
utilizing the network controller to generate a second signal corresponding to a first signal to a processor unit; and
utilizing the processor unit to control a image-capturing module to process digital signals of images captured by the image-capturing module.

9. The method of claim 8, wherein the image-capturing module further is used to transform the images into digital signals.

10. The method of claim 8, wherein the processor unit consists of a first and second processors.

11. The method of claim 10, wherein a first memory is electrically connected to the first processor for storing data and program codes of the first processor.

12. The method of claim 11, wherein a third memory is electrically connected to the first memory and used for storing the digital signals of the images.

13. The method of claim 10, further comprising: utilizing the second processor to receive the second signals to correspondingly generate a third signal to the first processor.

14. The method of claim 10, wherein a second memory is electrically connected to the second processor for storing data and program codes of the second processor.

15. The method of claim 10, wherein the network controller is electrically connected to the second processor for receiving the first signals transmitted from the external network.

16. The method of claim 13, further comprising: utilizing the first processor to control the image-capturing module with the third signal.

17. The method of claim 8, wherein the image-capturing module comprises a lens set and a plurality of light-sensing cells for receiving light transmitted from the lens set and for transforming the light into the digital signals of the images.

18. The method of claim 8, wherein the external network belongs a wireless, an Internet, or a local area network.

19. The method of claim 8, further comprising: utilizing the processor unit to control the image-capturing module to transmit the digital signals of images back the remote computer via the network for displaying the images in real time.

20. The method of claim 8, further comprising: utilizing the processor unit to control the image-capturing module to transmit the digital signals of images to an external receiving terminal via the network.

21. The method of claim 20, wherein the external receiving terminal is a file server or a net working storage.

22. The method of claim 12, wherein the third memory is a compact flash card.

23. The method of claim 8, further comprising: utilizing the processor unit to control a flash controller, according to the first signals generated by the remote computer via the network, thereby adjusting a flash of the image-capturing module.
